(19) United States
(12) Patent Application Publication
(10) Pub. No.: US 2008/0166692 A1
(43) Pub. Date: Jul. 10, 2008

(54) SYSTEM AND METHOD OF REINFORCING LEARNING

(76) Inventors: David Smith, Chandler, AZ (US); Rich Petko, Queen Creek, AZ (US)

Correspondence Address: SNELL & WILMER L.L.P. (Main), 400 EAST VAN BUREN, ONE ARIZONA CENTER, PHOENIX, AZ, 85004-2202, US

(21) Appl. No.: 11/971,009

(22) Filed: Jan. 8, 2008

Related U.S. Application Data
(60) Provisional application No. 60/883,940, filed on Jan. 8, 2007.

(51) Int. Cl. G09B 7/00; G09B 7/02

(52) U.S. Cl. 434/322; 434/362

(57) ABSTRACT

Embodiments of the present invention comprise an interactive educational environment including educational games deployed in a computing environment, where the games provide a life-like simulation of a concept about which a student has recently been instructed. The games provide different scenarios and the tools that would be utilized in the real-world situation, allowing the user to make life-like decisions without the real-world risk associated with the decisions. The educational games may be adaptable to a particular student such that the games reinforce teaching and learning in a way that is suitable and most effective to the particular student. Learning may be reinforced by the use of a morale indicator that is configured to indicate the overall morale resulting from a particular user's decision. The educational games may be configured to reside in an overall approach to teaching and learning that comprises sets of central and peripheral nodes, where each peripheral node becomes the central node for a subsequent set of peripheral nodes.

### RELATED APPLICATION

This application claims the benefit of U.S. Provisional Application No. 60/883,940, entitled “SYSTEM AND METHOD OF REINFORCING LEARNING” filed on Jan. 8, 2007, the entire content of said provisional application being expressly incorporated herein by reference.

### FIELD OF INVENTION

The present invention relates to an interactive educational system for reinforcing learning. More specifically, the present invention relates to interactive educational systems that reinforce learning by utilizing educational games and other techniques deployed on a computing device, where the educational games simulate real-world experience and decision-making.

### BACKGROUND OF THE INVENTION

Educational games are generally known in the art. For example, the game of flash cards is a type of game that may be used to aid in memorization. Computerized educational games exist that can help individuals learn reading, spelling, mathematics, geography, and other subject matter. Even though educational games are known in the art, they have only recently been employed by teaching and/or learning institutions as computer technology and network access has become more commonplace. Thus, new advances are continuously being made in methods of teaching and/or learning via an interactive, computerized, gaming application.

However, many of these educational computer games are limited in that specific software is necessary in order to run a single game, and in some cases specific hardware may be required. Specific hardware and software contributes significantly to the cost of the educational games that are known. Many educational games are also limited in that they only provide a pre-set number and type of learning experiences—they are not adaptable to the specific individual using the game.

Some games makers have attempted to solve this problem by deploying educational games via the Internet, so that all that is required to operate the game is an Internet web browser such as Microsoft's Internet Explorer or Mozilla's Firefox and a single additional piece of software. Software is currently available that may be incorporated into a Web browser and that may run many types of educational games. Such software is sometimes referred to as a “virtual machine” and the Adobe Flash Player is an example of a virtual machine. The virtual machine is also sometimes referred to as a client application. Educational software is created for the client application via an integrated development environment (IDE).

The Adobe Flash Player is a known means for adding animation, advertisements, interactivity, web components, games, and other functionality to Web pages. Of the games that do exist for the Flash Player, most are not overly-complex and are not generally adaptable to the particular student who is using the game for an educational experience. Those games and educational games that are more complex typically require highly sophisticated and/or complex engines that have been modified from engines that exist for traditional gaming in order to function in an educational setting.

Various games currently exist that are objective and goal-based games in which players use an isometric avatar—a graphical image in a computer game that represents a user and/or player—to explore the environment and interact with objects and in-game characters. It would be desirable to have these types of games available in a ubiquitous and versatile platform, such as a virtual machine or the Adobe Flash Player.

Accordingly, there exists a need for complex educational games that are adaptable to particular students and that are capable of specifically reinforcing topics and other items that have been recently taught in a classroom or other learning environment. Similarly, a need exists for such educational games that can be deployed in an Internet browser or other similar common computing environment, for example via a virtual machine or client application such as the Adobe Flash Player.

### SUMMARY OF THE INVENTION

While the way that the present invention addresses the disadvantages of the prior art will be discussed in greater detail below, in general, the present invention provides for an interactive educational environment including educational games deployed in a computing environment, where the games provide a life-like simulation of a concept about which a student has recently been instructed. The games provide different scenarios and the tools that would be utilized in the real-world situation, allowing the user to make life-like decisions without the risk associated with the decisions. In general, each scenario is customizable by the user in terms of set-up and character appearance. The educational games are adaptable to a particular student such that the games reinforce teaching and learning in a way that is suitable and most effective to the particular student. The educational games reside in an overall approach to teaching and learning that comprises sets of central and peripheral nodes, where each peripheral node becomes the central node for a subsequent set of peripheral nodes. As a user proceeds through the game, the player's choices and progress may influence the overall morale of the simulated environment in which he is participating, and a graphical display may be used to show the player the level of the overall morale.

### BRIEF DESCRIPTION OF THE DRAWINGS

A more complete understanding of the present invention may be derived by referring to the detailed description and claims when considered in connection with the Figures, wherein like reference numerals refer to similar elements throughout the Figures, and

FIG. 1 illustrates the process flow of an educational game according to an embodiment of the present invention;

FIG. 2 illustrates an exemplary game interface;

FIG. 3 illustrates an exemplary game interface and in-game tools; and

FIG. 4 illustrates, in symbolic form, central nodes and peripheral nodes for various levels of an educational process, according to an embodiment of the present invention.

### DETAILED DESCRIPTION

The following description is of exemplary embodiments of the present invention only, and is not intended to limit the scope, applicability or configuration of the invention. Rather, the following description is intended to provide a convenient illustration for implementing various embodiments of the present invention. As will become apparent, various changes may be made in the function and arrangement of the elements, steps and functions described in these embodiments without departing from the scope of the invention as set forth herein. It should be appreciated that the description herein may be adapted to be employed with alternatively configured methods having different steps, processes, functionality and the like and still fall within the scope of the present invention. Thus, the detailed description herein is presented for purposes of illustration only and not of limitation.

In accordance with various embodiments of the present invention, an educational game is disclosed which is configured to be deployed on a computing device. The present invention may be used to provide a Flash-based delivery platform of gaming elements that provides a mechanism to practice-without risk the elements of previously facilitated instruction. The educational game, according to preferred embodiments of the present invention, is a complementary experience of isometric perspective, including first-person and third-person perspectives of the graphical environment and interactions. An isometric perspective is a method of expressing a three-dimensional space within the confines of a two-dimensional area such as a computer screen. Thus, an exemplary embodiment of the present invention provides a highly-detailed, 3D-like environment to explore certain concepts that have recently been taught to and/or learned by a user.

In further embodiments of the present invention, the educational game comprises a practice-without-risk method of applying principles, ideas, methodology and the like from lessons that have just been learned. For example, the educational game is a tool that simulates a real-world experience and a real-world decision-making environment. Teachers provide instruction and concepts in learning and the educational game places the learner in a situation where he is immersed in a situation he has just been taught to handle. The educational game is able to change based on decisions a user makes. Thus, exemplary embodiments provide an educational game that is adaptable to specific students, teachers, lessons, methodology, and so forth. Additional embodiments of the present invention provide Flash-based games or games deployed through other virtual terminals or client applications that are substantially more involving and/or more complex than traditional games that have been developed using existing virtual terminal applications.

In another embodiment of the present invention, the educational game is directed to a particular class of individuals and students who are accustomed to using computers and other technology. For example, an exemplary embodiment employs computer technology to provide an interactive, life-like, easy to use, educational environment to reinforce lessons that have recently been taught and/or learned in a particular teaching/learning environment. In a further embodiment, a life-like business environment is represented in the educational game. Students who are accustomed to using computers and other technology, for example, are generally amenable to learning by and employing such a game.

According to a further embodiment of the present invention, the educational game is adaptable and customizable according to particular students and other users. For example, the educational game is present in a flexible environment, such that the educational game is skinnable. In computer software, skins and themes are generally defined customizable graphical appearances that can be changed according to desires of a user. Colors, modules, toolbars, toolbar elements, command bars, icons, and the like are subject to change in a skinnable game. For example, various embodiments of the present invention provide that a user may select different environments such as a business office, a dungeon, planet Mars, a deserted island, a high-rise conference room and the like. For example, game environments range from the classic survivor-island scenario to high-rise financial planning meetings. A user may also change the character which embodies the user in the game such that the characters may be formal or casual with differing ages, gender, ethnicity, etc. Tools employed in the game are also wide-ranging, from game-based personal digital assistants (PDA's) and computers to imagined futuristic devices. Thus, preferred embodiments of the present invention provide a customizable game-playing environment according to preferences of a particular user.

In various embodiments of the present invention, the educational game user interacts with non-player characters in the game environment. Such non-player characters are sources of information the player may use to accomplish his goals in the game. Methods of interaction with such non-player characters may comprise, for example, taking and/or conducting a site survey on a clipboard, clicking on the non-player character to get a response to an inquiry and/or to answer a question, receiving possible decisions, and the like. Information a player receives from a non-player character and from other information sources in the game may be collected in ways both relying on the player's memory and in ways not relying on the player's memory. For example, a player may use electronic notes and recording dialogues using an actual or simulated PDA and other tools.

In accordance with an exemplary embodiment of the present invention, the educational game simulates an interaction between a new employee and a person at his new place of employment, for example, a human resources director. The human resources director appears on the educational game and tells the user (i.e., the new employee) that his office is down the hall. The user learns how to interact in a business environment by choosing how to respond to the human resources director. For example, if the user repeatedly asks where his office is located, the human resources director will get more and more agitated each time she has to repeat the answer. Where the director becomes more and more agitated, the overall morale of the company may decrease, and the user may see this decrease in overall morale as a result of his choices. Thus, different students and/or users who act differently with the simulated human resources director will receive different results and feedback from the educational game.

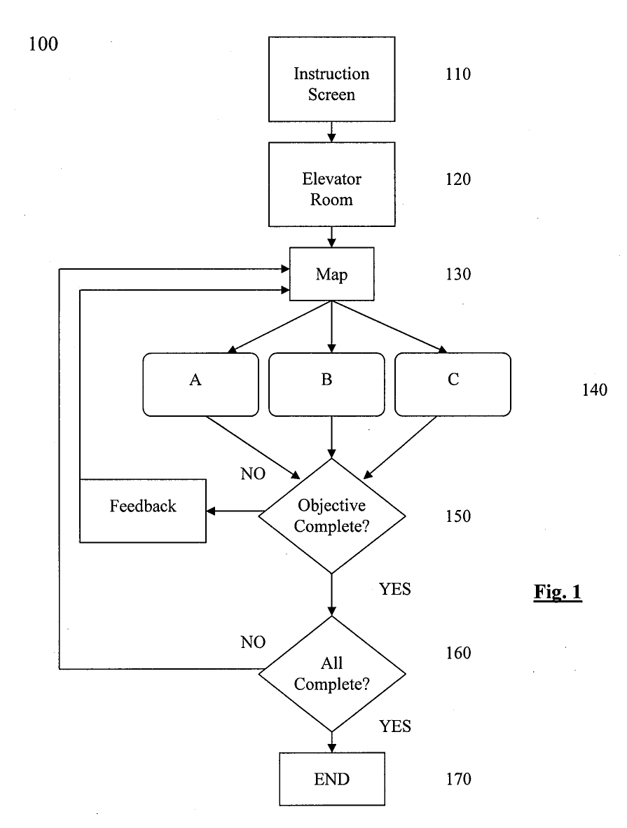

Referring to FIG. 1, an exemplary embodiment of the invention will now be described by means of a simulated interaction between the educational game 100 and a user. It should be understood that the following description is only one example of the flow of the educational game and does not limit the multitude of variations associated with the invention. For example, the educational game may be described as an Elevator Game, because the user begins in an elevator room in an office building. When the game launches, the user is presented with an instruction screen 110. The instruction screen 110 may include, for example brief instructions about how to navigate through the game. In another embodiment, the introduction screen introduces the user to different individuals he will encounter throughout the game, so, for example, the user may know how to communicate and/or interact with the different individuals.

As the educational game begins, the user is in an elevator room 120 where he is presented with several options, for example: Play, Tutorial, About, and Exit. The elevator room 120 is the portal into the game scenario and can open to a wide realm of possibilities. Choosing the Exit options terminates the game. Choosing About describes the contributors to and authors of the educational game. The Tutorial provides more in-depth instructions on how to use the educational game. Play opens the elevator doors and begins the game.

As the elevator door opens, a map 130 is presented which shows the user different areas 140 through which the user needs to navigate. In certain embodiments of the present invention, there is a non-player character who can aid in deciding which direction to take. The user chooses an area and the avatar, which represents the user, goes to that area. In each area, some portion of a lesson is reinforced such that the user may apply the knowledge he gained in a lesson taught prior to playing the game. Various embodiments provide certain objectives associated with the different areas 140, where the objectives may be customized according to the needs and or desires of a particular student. For example, an objective may be to collect certain items or talk with certain non-player characters.

In various embodiments, if an objective is not met, then feedback 160 is provided in order to reinforce learning, and the student is returned to the map 130, where he can choose the same area/objective 140 and attempt to complete it, or he may choose another area and retry the first area later. If the objective is completed 150, the user returns to the map to choose a different area. This process continues until all the objectives have been achieved 160, at which point the user may end the game 170. In another embodiment, the user may save his progress and return to the same place he left off, and a user may repeat already-completed objectives in order to reinforce learning and/or to study. In further embodiments of the present invention, a user may need to use inventory items collected in different areas in order to succeed in completing a subsequent objective.

In accordance with one embodiment of the present invention, several different views are available to the user as he navigates through the different areas of the game. For example, an isometric view, which displays a 3D-like image on the 2D computer screen, shows a computer image of the user and allows the user to navigate to different areas of the game environment. In one embodiment, the user navigates to different offices in an office building. The isometric view, for example, contributes to the life-like scenario being carried out in the game. Other embodiments have first-person and third-person views which the user may choose. In further embodiments, the views have simple and colorful interfaces though which the user interacts with the game. For example, various embodiments provide controls for in-game help, restarting the game, controlling the sound, displaying messages and objectives, displaying the score, showing inventory items, choosing tools, and the like.

According to further embodiments of the present invention, the user employs in-game tools in order to interact with the game. Examples of such tools are a PDA, clipboard, laptop computer, cell phone, MP3 player, and the like. In a preferred embodiment, all real-world tools that would be available in a particular situation are available in the simulated situation of the present invention. In other embodiments, these items may be picked up by the user and maintained in inventory. The MP3 player, for example, is capable of playing a number of music files such that a user may further customize the game experience. In another preferred embodiment, the in-game tools include futuristic tools or tools which a user may design to aid during the game. Another tool is an area on the interface that displays the current objective for the user to accomplish.

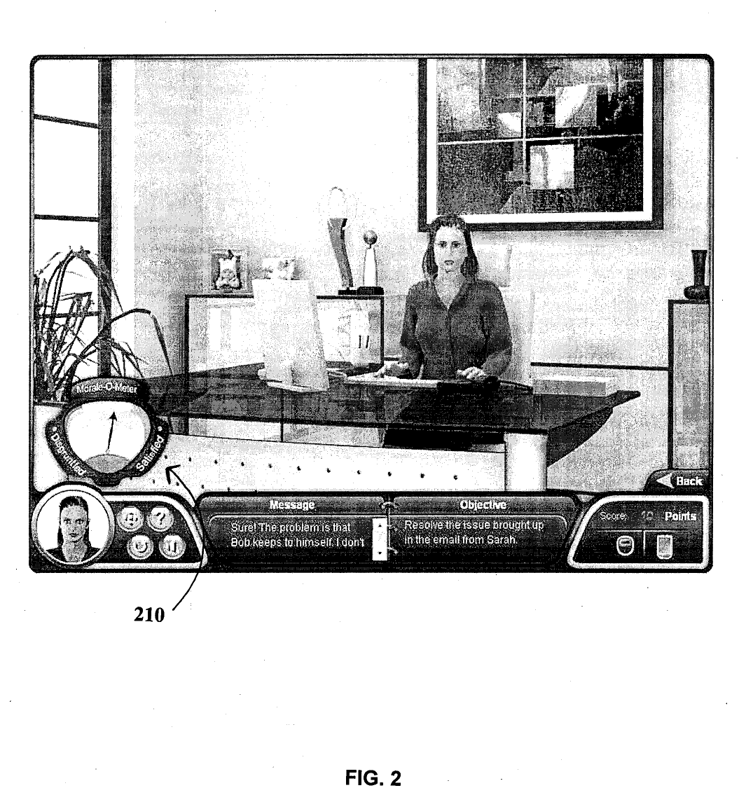

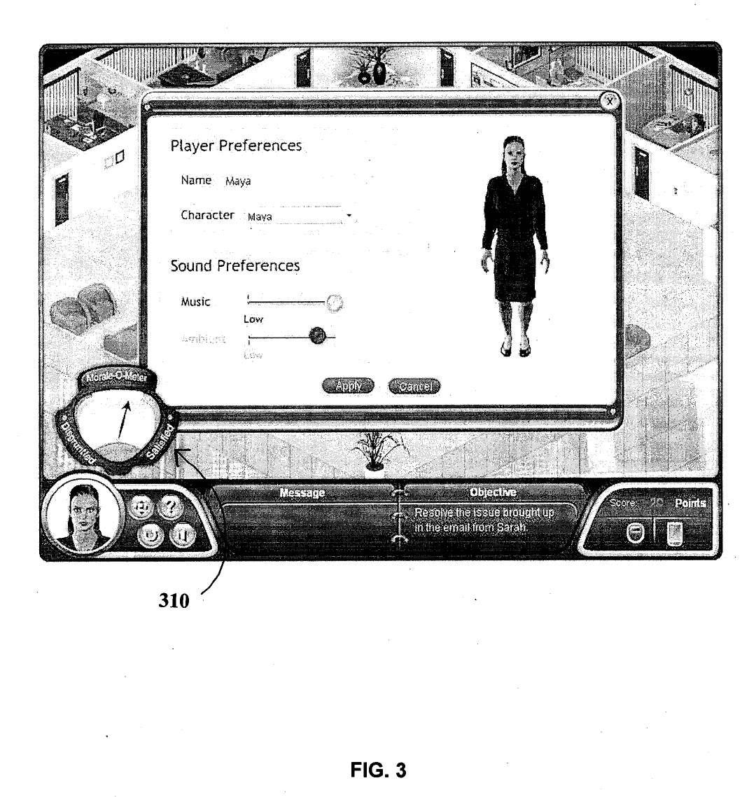

With reference to FIG. 2 and FIG. 3, an exemplary embodiment of the present invention provides a tool 210, 310 that indicates the overall morale of the environment in which the user is playing the educational game. This morale tool 210, 310 may be referred to as a morale indicator or a Morale-O-Meter. This tool reflects the cumulative overall morale (e.g., for the entire company or organization) that results from each of the choices and/or decisions which the player makes. The morale indicator 210, 310 aids, for example, in providing immediate feedback for the user so the user can learn from the choices he makes. Moreover, another exemplary embodiment provides a gauge or indicator that provides feedback to the user of recent game decisions. In an exemplary embodiment, the gauge or indicator is not necessarily limited to morale, but can also include points, health, or additional emotional attributes.

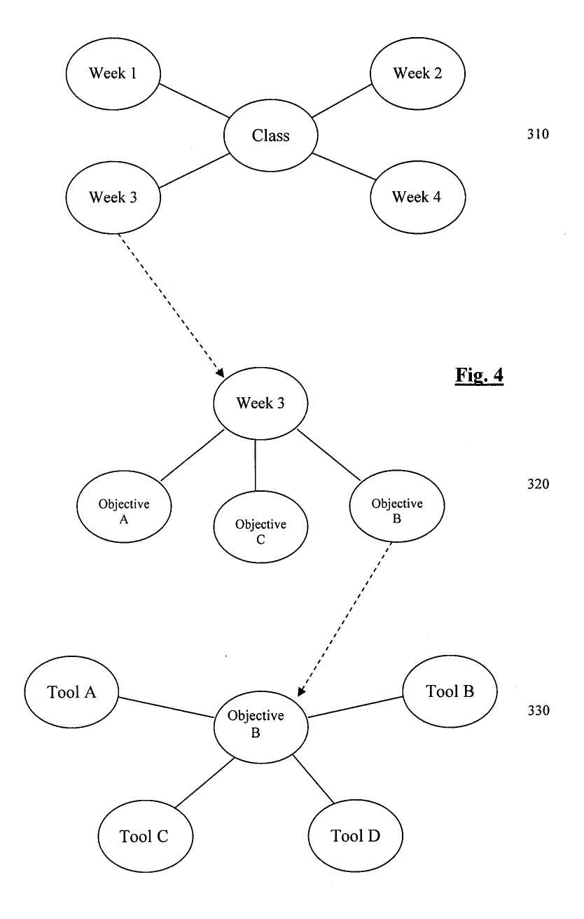

In accordance with a further exemplary embodiment of the present invention, the educational game exists and/or resides within a larger, overall teaching and instructional method. Referring to FIG. 4, for example, the overall teaching and instructional method consists of instruction and concepts over a period of time 410, for example throughout the duration of a class (e.g., a semester). The focus of the instruction and concepts consists of a set of goals and/or objectives 420 that each student needs to learn. Around the periphery of the set of objectives lie several tools 430 for helping each student to achieve the goals. For example, one of the tools may comprise classroom, online, and/or virtual instruction and the like. Another tool may comprise the educational game that reinforces what a student has learned. Such reinforcement through the game may be tailored to each individual student thereby increasing the number of students who achieve the goals in the course.

In another embodiment of the present invention, the overall teaching and instructional method is implemented via a virtual machine or client application similar to the virtual machine used to make the educational game available to students. In various embodiments, the objectives are represented by a central icon or node, and the various tools are represented by nodes which circumscribe the central node. A user clicks on one of the tools in order to access that tool. Clicking on the node is similar to clicking on a hyperlink on an Internet web page, but clicking on the node brings up a tool within a virtual machine. In other embodiments of the present invention, the tools may be described as certain weeks in the course, and the user will be asked by the instructor to complete the tools in order. In other embodiments, the tools may be specific educational games and/or other educational learning and teaching tools.

In a further embodiment, the overall teaching and instructional method comprises several sets of central and circumscribing nodes. For example, if the central node is the main course objectives, and the circumscribing nodes are course weeks, then when a user clicks on one of the nodes representing a week, a new set of nodes appears and the new central node is the node representing a week, and the circumscribing nodes become particular tools, such as objectives, games, goals, etc. that are necessary for learning that week's topic. In various embodiments of the present invention, many sets of central and circumscribing nodes exist. To return to a previous set of nodes, the user clicks on the central node in the current set of nodes.

According to various embodiments of the present invention, particular tools that may be accessed via the sets of nodes comprise educational games, digital stories, external websites, simulations, electronic books, libraries, multimedia resources, and other supplemental learning materials. In a further embodiment, a tool that aids in teaching and learning and that is present with the sets of nodes is a running storyline. Such a storyline keeps a user informed of what is going on in the course, and this storyline updates automatically as a user moves from one node to another.

Similarly, while the present invention has been described herein as a method for reinforcing learning via an educational game, the present invention may be readily used with any number of games or other methods of reinforcing learning now known or hereafter developed.

Additionally, in an exemplary embodiment, a system and method of reinforcing learning includes a Multi User Virtual Environment (hereinafter “MUVE”) learning area. This MUVE learning area comprises a virtual campus that users can access via the internet and wherein users may interact with other users in a real-time environment. The virtual campus allows users from multiple locations to become classmates and network with one another. Advantages of a MUVE learning area over traditional real-world learning areas include the diversity of users who can be interacting from a wide variety of locations, the reduction of travel time by using the internet saves while still providing the benefit of user interaction, and the ability for a virtual campus to handle a virtually limitless student body and course offering by merely adding meeting locations via software. Additionally, guest lecturers and videos may be presented by people throughout the world, offering a wide selection of potential presenters.

In a further embodiment, the virtual campus allows a user to, for example, attend a lecture, interact with faculty, watch videos, listen to live and prerecorded audio streams, play games, participate in training events, and network with each other. To enhance the experience, a preferred embodiment provides the user the ability to customize his or her character/avatar. In an exemplary embodiment, customizations include selecting the avatar's gender, age, ethnicity, and clothing among other things. In another exemplary embodiment, the user is capable of performing tasks with an avatar, such as flying a plane, driving a car, or interacting with other users. The user can interact in real-time by implementing video clips, streaming audio, or text sharing.

In accordance with an exemplary embodiment of the virtual campus, various buildings are included on the virtual campus to provide a mixture of options. For example, potential buildings include a student lounge, a library, a media lab, a sandbox, an amphitheater, and themed areas. The student lounge may be configured to act as an initial entry point wherein instructional tutorial videos are available, the user can ask questions of the virtual campus staff, the user can select another campus area to visit, and the user can take other actions related to the virtual campus.

In an exemplary embodiment, the library may be configured to allow users to read e-books, such as open source and/or licensed e-books, and host small meetings. The media lab may be configured to allow users to watch videos of stories, and listen to live or prerecorded audio streams. The sandbox may be configured to allow virtual campus faculty to create custom virtual objects to demonstrate various course concepts. The amphitheater may be configured to be a large outdoor lecture hall to host classes and guest lectures.

According to another exemplary embodiment, the virtual campus may include themed areas. The themed areas may offer a chance to take advantage of the virtual nature of the learning environment by selecting historical or futuristic settings. For example, art classes may be taught in a building in Paris in the 1930's, Greek history or archeology classes may be taught in the Parthenon, and classes on justice and ethics may be taught in the wild west town of Tombstone where virtual criminals are hanged if found guilty.

While the present invention has been described above with reference to various exemplary embodiments, many changes, combinations and modifications may be made to the exemplary embodiments without departing from the scope of the present invention. For example, the various components may be implemented in alternative ways. These alternatives can be suitably selected depending upon the particular application or in consideration of any number of factors associated with the operation of the method. In addition, the techniques described herein may be extended or modified for use with other types of subject matter. These and other changes or modifications are intended to be included within the scope of the present invention.

What is claimed is:

1. A computerized method for reinforcing learning of a concept, comprising:
providing a graphical user interface configured to adapt to a plurality of learning-reinforcing scenarios;
presenting a plurality of elevator doors via the graphical user interface, wherein at least one of the plurality of doors comprises a learning-reinforcing game related to the concept;
receiving a user choice corresponding to one of the plurality of elevator doors;
assigning a chosen scenario from one of the plurality of learning-reinforcing scenarios, wherein the chosen scenario corresponds to the user choice;
modifying the graphical user interface according to the chosen scenario, thereby forming a skinnable game interface, wherein the skinnable game interface comprises a plurality of game tools, and wherein the plurality of game tools comprises a morale indicator;
presenting the chosen scenario via the skinnable game interface;
presenting a simulated non-user character configured to participate in the chosen scenario;
receiving a user decision associated with the simulated non-user character;
updating a morale value in response to the user decision; and
displaying the updated morale value via the morale indicator, thereby reinforcing learning of the concept.
